(19) United States
(12) Patent Application Publication
(10) Pub. No.: US 2005/0248215 A1
(43) Pub. Date: Nov. 10, 2005

(54) System for detecting low voltage in an electric appliance

(75) Inventors: Fabio Eduardo Rosa, Joinville (BR); Gerson Eguni, Rio Claro (BR)

Correspondence Address: DARBY & DARBY P.C., P. O. BOX 5257, NEW YORK, NY, 10150-5257, US

(73) Assignee: MULTIBRAS S.A. ELECTRODOMESTICOS, SAO PAULO-SP (BR)

(21) Appl. No.: 10/523,741

(22) PCT Filed: Aug. 15, 2003
(86) PCT No.: PCT/BR03/00116

§ 371 Date: Mar. 29, 2005

(30) Foreign Application Priority Data
Aug. 16, 2002 (BR) PI 0203311-9

(51) Int. Cl. H02J 1/00

(52) U.S. Cl. 307/38

(57) ABSTRACT

A system for detecting low voltage in an electric appliance having multiple loads (10) associated with drive switches (20) commanded by respective electronic controls (30) which are energized from a power source (40) connected to an electric network and which are operatively coupled to a command module (50). The system comprises: a compensating load (60), connected to the power source (40) and constructed to maintain constant the relation between the voltage of the electric network and the voltage of the power source (40), regardless of the number of loads (10) being energized; a control unit (70) associated with the command module (50) and with the compensating load (60), to define the current consumption to be produced by the compensating load (60), and a voltage sensing means (S) associated with the power source (40) and with the control unit (70) to promote the de-energization of the loads (10) when the voltage of the power source (40) is lower than a predetermined minimum value.

### FIELD OF THE INVENTION

The present invention refers to a system for detecting low voltage, to protect electronic controls that command the operation of the drive switches of electric appliances with multiple loads, such as refrigerators, freezers, and other appliances or facilities. The invention is particularly related to a system for de-energizing the electronic controls that command the drive switches of electric appliances, interrupting the supply of electric power to said controls and to the loads operatively associated therewith, so as to disable said electronic controls and said loads when the supply voltage is lower than a predetermined minimum value.

### BACKGROUND OF THE INVENTION

Electric appliances, such as refrigerators and freezers, present different electrically energized devices (loads), such as the compressor, the fan, defrost resistances, lights, etc., whose actuation is commanded by respective electronic controls that command the drive switches, generally relays provided with DC coils.

The electronic controls that activate the drive switches of different devices in an electric appliance are specified to operate correctly within a voltage range. In case low voltage occurs during energization of these electronic controls with an electric voltage below the specified voltage, the different devices of the electric appliance will be able to continue to operate with said low voltage, if the latter is still sufficient to maintain the appliance under operation. However, the low voltage supply to the electronic controls generally causes the incorrect operation and also the reduction of the useful life of some components, more particularly the relays that activate the inductive loads.

In the electric appliances, such as refrigerators, in which there are provided different devices or loads, the operation of the latter is commanded by an electronic control module, which is programmed to enable and disable the switches (generally relays) for energization of the different loads of the appliance, as a function of the desired working conditions. In these appliances, a command module and the different electronic controls are energized from a generally DC power source, which in turn is supplied from an electric network for energization of the appliance.

In such conditions, in which the operating status of the different loads of the appliance varies constantly, the relation between the AC voltage of the electric network that supplies the power source and the DC voltage that the power source supplies to the different electronic controls that command the switches and to the command module, ceases to be constant. The more loads are switched on upon energization (enabling) of their respective switches, the lower will be the DC voltage of the power source in relation to the AC voltage of the electric network. As the switches of the different loads are opened and the electronic controls thereof de-energized, the DC voltage of the power source increases in relation to the voltage of the electric network.

By reason of the characteristics of the electric appliances with multiple loads, as mentioned above, the usual control of the voltage value of the electric network for protecting the different electronic components of the appliance has proved to be inadequate, particularly when said appliances are used in regions in which the low voltage conditions are frequent, usually defining a working reality to said appliances.

The existing low voltage detecting systems, by reasons of constructive simplification and costs, actuate on the voltage of the electric network. In this type of control, in case the electric network minimum voltage, which is specified for the operation of the control module, corresponds to a voltage of the power source with only part of the loads under operation, for example when only the compressor is working, when other loads are activated by the enabling (energization) of the electronic controls of their switches by the command module, the voltage of the power source will be lower, modifying its relation with the voltage of the electric network, even with the voltage of the electric network remaining in the same value.

In this situation, the command module can continue to operate because the voltage of the electric network is sufficient for the proposed system, even with the voltage of the power source having been reduced by the increase of the enabled loads to values that will cause the inadequate operation of the electronic controls, substantially reducing the useful life thereof.

A solution to eliminate the deficiency above is to detect the acceptable minimum voltage level at the outlet of the power source and not at the inlet thereof.

However, while allowing the effective low voltage value to be detected in at least one of the drive switches of a load that defines the critical value to be respected, this solution for detecting low voltage of the power source presents an operating problem that makes infeasible the application thereof. In said solution, the disabling of the switches with different loads upon detection of a low voltage value that is unacceptable to the electronic controls tends to provoke a consequent rise of the voltage of the power source, re-enabling the supply of the switches, leading to a new disabling and so forth, until either the voltage of the electric network rises to a value which produces an acceptable voltage of the power source, or the alteration of the status of the loads produces the necessary rise in the voltage of the power source.

Other systems for detecting low voltage in electronic controls are possible in different levels of sophistication, but which invariably lead to a substantial increase in the cost of the involved means.

### OBJECTS OF THE INVENTION

By reason of the problems mentioned above, it is a general object of the present invention to provide a system for detecting low voltage in the electronic controls that command the drive switches of several loads of electric appliances, which presents a simple construction, and which has little or no negative interference in the costs of the systems being used, and allowing said electronic controls and the loads driven thereby to be operatively disabled when the supply voltage of said electronic components is lower than a predetermined minimum value.

It is a specific object of the present invention to provide a detecting system such as mentioned above, which allows the supply voltage of the electronic controls to maintain a substantially constant relation with the voltage of the electric network that supplies the electric appliance, regardless of the number of the loads enabled in the latter.

### SUMMARY OF THE INVENTION

The invention is directed to a system for detecting low voltage in an electric appliance, such as a refrigerator or a freezer, presenting multiple loads to be energized by drive switches commanded by respective electronic controls, which are energized by a power source connected to an electric network that energizes the loads and which are operatively coupled to a command module that defines the activation of the loads.

According to the invention, the detecting system comprises: a compensating load, energized by the power source and which is constructed so as to maintain constant the current consumption of the power source and the relation between the voltage of the electric network and the voltage of the power source, regardless of the number of loads being energized; a control unit operatively associated with the command module and with the compensating load, in order to define the current consumption to be produced by the compensating load, as a function of the energization state of the different loads; a voltage sensing means operatively associated with the power source and with the control unit, so that the latter produces, through the command module and through the drive switches, the de-energization of the loads when the voltage of the power source is lower than a predetermined minimum value.

### BRIEF DESCRIPTION OF THE DRAWINGS

The invention will be described below, with reference to the enclosed drawings, given as a way of example for an embodiment of the invention and in which:

FIG. 1 is a simplified flowchart of the means that define the present detecting system, when applied to an electric appliance presenting three loads to be energized by drive switches controlled by respective electronic controls operatively associated with a command module; and

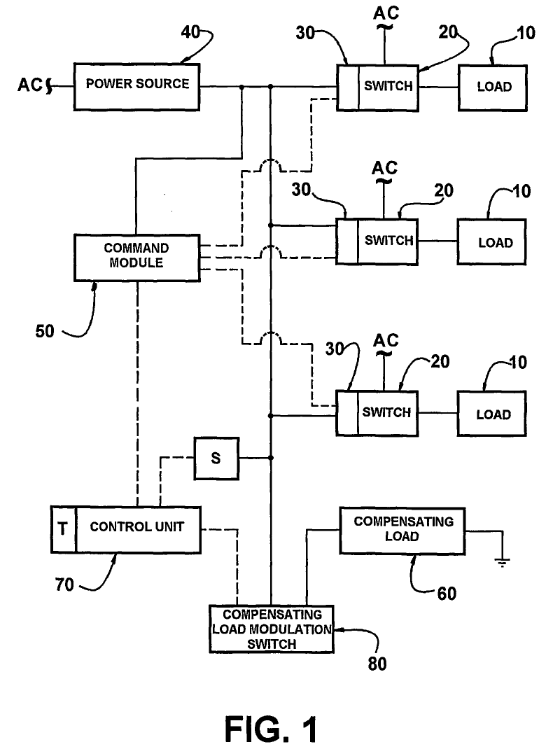

FIG. 2 is a simplified flowchart of a possible construction for the circuit that supplies current to the compensating load.

### DESCRIPTION OF THE ILLUSTRATED EMBODIMENT

As illustrated in the drawings and as mentioned above, the present detecting system is applied to protect the electronic components that command the operation of electric appliances, such as refrigerators, freezers, and the like, presenting different loads 10, which can take the form of, for example, a compressor, a fan, an electric resistance, etc., and whose activation, upon energization from an AC electric network, is made by respective drive switches 20, which are operated by respective electronic controls 30 associated therewith, as a function of the working requirements of the electric appliance.

The electronic controls are arranged in parallel, generally DC energized from a power source 40 connected to said AC electric network. The electronic controls 30 are operatively coupled to a command module 50, generally energized from the power source 40 and which is constructed to command the activation of the different loads 10, by the energization of the electronic controls 30 of the respective drive switches 20. The command module 50 may present any known construction that is normally used to command the automatic drive of different loads of an electric appliance, as a function of the operational parameters selected by the user.

According to the invention, there is provided a compensating load 60 energized from a power source 40, connected parallel to the electronic controls 30, and which is constructed so as to maintain constant the current consumption of the power source 40, regardless of the number of loads 10 that are activated.

The construction of the compensating load 60 mentioned above allows the relation between the voltage of the electric network and the voltage of the power source to be maintained constant, regardless the energization condition of the electronic controls 30 by instruction of the command module 50.

The compensating load 60 is constructed and incorporated to the present detecting system, so as to have its current consumption varying, automatically, from a minimum value, which is generally zero when all the loads 10 are energized by activation of the electronic controls of the respective drive switches 20 to a maximum value when all the loads are de-energized.

Said maximum value of the current consumption produced by the compensating load 60 corresponds, preferably, to the sum of the current consumptions produced by the electronic controls 30 of the drive switches 20 of all loads when energized.

In the preferred construction, the value of the current consumption produced by the compensating load 60 will be always equal to the difference between the maximum current consumption of the power source 40, when all the loads 10 are activated, and the current consumption of the power source 40 at that moment.

The present detecting system further comprises a control unit 70 operatively associated with the command module So and with the compensating load 60, in order to define the current consumption to be produced by the compensating load 60, as a function of the energization state of the different loads 10, that is, the state of the respective drive switches 20 and their electronic controls 30.

The command module 50 informs the control unit 70 about the energization state of the electronic controls 30, allowing the control unit 70 to process this information, estimating the current consumption of the power source 40 at each moment, as a function of the number of electronic controls 30 activating the respective drive switches 20.

In the preferred and illustrated construction, the variation of the current consumption of the compensating load 60 is obtained by pulse width modulation of energization of the compensating load 60, by means of a modulation switch 80 operatively associated with the unit control 70.

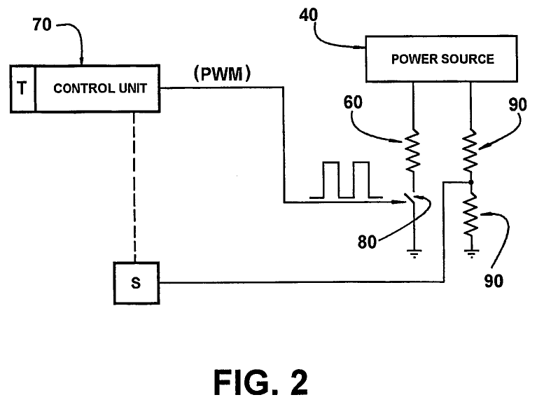

The control unit 70 produces, as a function of the information received from the command module 50 about the state of the electronic controls 30, a pulse width modulation (PWM) signal that activates the modulation switch 80 in a way to control the current to be consumed by the compensating load 60, which in the example illustrated in FIG. 2 takes the form of a resistance with a constant value.

The frequency of the PWM signal is generally 50 Hz and the duty cycle of the modulation switch 80 varies according to the control logic of the control unit 70. The present detecting system further comprises a voltage sensing means S, operatively associated with the power source 40 and with the control unit 70 for detecting the voltage level of the power source 40. A sample of the current voltage of the power source 40 is obtained by a sensing means S in the form of an analog to digital converter connected to a resistive divider 90, which reduces the signal according to the input limits of the analog to digital converter.

When the value of the voltage of the power source 40, which is obtained by the voltage sensing means S and transmitted to the control unit 70 and to the command module 50, is lower than a predetermined minimum value, the command module 50 produces, by means of the drive switches 20, the de-energization of the loads 10.

In order that voltage drops of short duration of the electric network do not produce de-energization of the loads 10, the system is provided with a timer T which is operatively associated with the control unit 70 to hinder the de-energization of the loads 10 caused by low voltage situations occurring in the power source output with a duration that is inferior to a predetermined period of time. With the provision of said timer, the cut-off of the loads of the electric appliance is avoided upon the occurrence of abrupt and rapid drops of the voltage of the electric network, said drops having a duration that is insufficient to characterize a low voltage situation that is prejudicial to the electronic controls.

1. A system for detecting low voltage in an electric appliance having multiple loads (10) energized by drive switches (20) commanded by respective electronic controls (30), which are energized from a power source (40) connected to an electric network for energizing the loads (10), and which are operatively coupled to a command module (50) FOR driving the loads (10), characterized in that it comprises: a compensating load (60), energized by the power source (40) and which is constructed to maintain constant the current consumption of the power source (40) and the relation between the voltage of the electric network and the voltage of the power source (40), regardless of the number of loads (10) being energized; a control unit (70) operatively associated with the command module (50) and with the compensating load (60), in order to define the current consumption of the compensating load (60), as a function of the energization state of the electronic controls (30); and a voltage sensing means (S) operatively associated with the power source (40) and with the control unit (70), so that the latter produces, through the drive switches (20), the de-energization of the loads (10) when the voltage of the power source (40) is lower than a predetermined minimum value.

2. A system according to claim 1, characterized in that the compensating load (60) has its current consumption varying, automatically, from a minimum value, when all the loads (10) are energized, to a maximum value when all the loads (10) are de-energized.

3. A system according to claim 2, characterized in that the minimum value of current consumption produced by the compensating load (60) is zero, whereas the maximum value of said current consumption is that corresponding to the sum of the current consumptions produced by the electronic controls (30) of the drive switches (20) of all the loads (10) when energized.

4. A system according to claim 3, characterized in that the value of the current consumption produced by the compensating load (60) is equal to the difference between the maximum current consumption of the power source (40), with all the loads (10) being activated, and the instantaneous current consumption of the power source (40).

5. A system according to claim 1, characterized in that the energization state of the electronic controls (30) is informed to the control unit (70) by the command module (50).

6. A system according to claim 2, characterized in that the variation of the current consumption of the compensating load (60) is obtained by pulse width modulation for energization of the compensating load (60).

7. A system according to claim 6, characterized in that the energization of the compensating load (60) is made through a modulation switch (80) operatively associated with the control unit (70).

8. A system according to claim 6, characterized in that the compensating load (60) is defined by a resistance of a constant value.

9. A system according to claim 1, characterized in that it further comprises a timer (T) operatively associated with the control unit (70) for impeding the de-energization of the loads (10) upon occurrence of low voltage situations in the power source (40) with a duration inferior to a predetermined period of time.

10. A system according to any one of the previous claims claim 1, characterized in that the electric appliance is a refrigerator or a freezer.
